(19) United States
(12) Patent Application Publication
(10) Pub. No.: US 2026/0288902 A1
(43) Pub. Date: Sep. 24, 2026

(54) TRAINING DEVICE, TRAINING METHOD, AND RECORDING MEDIUM

(71) Applicant: NEC Corporation, Tokyo (JP)

(72) Inventors: Yoichi ISHIBASHI, Toyota (JP); Taro Yano, Tokyo (JP); Masafumi Oyamada, Tokyo (JP)

(73) Assignee: NEC Corporation, Tokyo (JP)

(21) Appl. No.: 19/561,786

(22) Filed: Mar. 10, 2026

(30) Foreign Application Priority Data
Mar. 18, 2025 (JP) 2025-043739

(51) Int. Cl. G06F 18/214; G06N 5/02

(52) U.S. Cl. CPC G06F 18/214; G06N 5/02

(57) ABSTRACT

In the training device, the data-with-thought generation means generate text data with thought to which thought process information is added based on input text data. The training means trains a training target language model by using the text data with thought.

### INCORPORATION BY REFERENCE

This application is based upon and claims the benefit of priority from Japanese Patent Application 2025-043739, filed on Mar. 18, 2025, the disclosure of which is incorporated herein in its entirety by reference.

### TECHNICAL FIELD

The present disclosure relates to training of a language model.

### BACKGROUND ART

In recent years, large language models (hereinafter referred to as LLMs) have been widely used. When using an LLM, performance is improved by further training an existing LLM. JP 2025-10993A describes an example of a training device that performs additional LLM training.

### SUMMARY

LLM training is roughly divided into two steps of pre-training and post-training. Pre-training is a step of training the LLM on a large amount of data to acquire grammar, word meanings, and knowledge. On the other hand, post-training is a step of fine-tuning a pre-trained LLM to improve its performance. In post-training, there is a method of enhancing the inference capability of the LLM. In this method, it is common to prepare text data for enhancing the inference capability and train the LLM. Therefore, the conventional method has a problem that only text data satisfying a specific condition can be used.

One object of the present disclosure is to provide a training method capable of enhancing the ability of LLM using any text data.

According to an example aspect of the present invention, there is provided a training device comprising

a data-with-thought generation means configured to generate text data with thought to which thought process information is added based on input text data, and

a training means configured to train a training target language model by using the text data with thought.

According to another example aspect of the present invention, there is provided a training method executed by a computer, comprising

generating text data with thought to which thought process information is added based on input text data, and

training a training target language model by using the text data with thought.

According to still another example aspect of the present invention, there is provided a program for causing a computer to execute processing of

generating text data with thought to which thought process information is added based on input text data, and

training a training target language model by using the text data with thought.

### EFFECT

According to the present disclosure, it is possible to provide a training method capable of enhancing the ability of LLM using any text data.

### BRIEF DESCRIPTION OF THE DRAWINGS

FIG. 1 illustrates an overall configuration of an LLM training device according to the present disclosure;

FIG. 2 is a block diagram illustrating a hardware configuration of the LLM training device;

FIG. 3 is a block diagram illustrating a functional configuration of the LLM training device;

FIG. 4 schematically illustrates an example of a thought generation method;

FIG. 5 schematically illustrates another example of the thought generation method;

FIG. 6 schematically illustrates another example of the thought generation method;

FIG. 7 schematically illustrates an example of a training method;

FIG. 8 schematically illustrates another example of the training method;

FIG. 9 schematically illustrates another example of the training method;

FIG. 10 schematically illustrates another example of the training method;

FIG. 11 schematically illustrates another example of the training method;

FIG. 12 schematically illustrates another example of the training method;

FIG. 13 schematically illustrates another example of the training method;

FIG. 14 schematically illustrates another example of the training method;

FIG. 15 is a flowchart of training processing;

FIG. 16 is a flowchart of another training processing;

FIG. 17 is a block diagram illustrating a configuration of the training device according to the present disclosure; and

FIG. 18 is a flowchart of processing by the training device.

### EXAMPLE EMBODIMENTS

Hereinafter, preferred example embodiments of the present disclosure will be described with reference to the drawings.

### First Example Embodiment

### Basic Concept

The present disclosure provides a technique for enhancing the LLM inference capability. The LLM inference capability refers to intelligent processing that requires “long thought”, and examples thereof include mathematics and programming. The conventional LLM tends to give an immediate answer without deep consideration, and it has been difficult to enable advanced intelligent processing. However, in recent years, the focus has been on enhancing the inference capability toward building AI agents that replace human economic activities.

In an existing LLM post-training method, the LLM is trained by preparing a specific task and specific data for which “correct/incorrect determination is clear”. A specific task is, for example, a mathematical task, a programming task, or the like, and specific data is, for example, a mathematical problem and an answer, a programming code and an execution result of the code, or the like. However, such a task for which “correct/incorrect determination is clear” is limited. Due to this limitation, there are many texts for training the LLM, but these texts cannot be used.

Therefore, the present disclosure proposes a method of enhancing the LLM inference capability using any text data, independent of specific tasks. When a problem is given, generating a thought process and then generating a final answer rather than generating an answer immediately greatly improves the inference capability. Therefore, how to make a thought process is important. In any text, there are authors who have written it. If the LLM could be used to mimic the author’s thought, the text could be generated, which would lead to an enhanced inference capability. Therefore, in the present disclosure, any text data is input into the LLM, and the thought of the author who has written the text data is predicted to create “text data with thought”. Then, the training target LLM is trained using the text data with thought. In the method of the present disclosure, by adding thought to text data and training the LLM, inference capability can be enhanced without changing the structure (network architecture) of the LLM.

### Overall Configuration

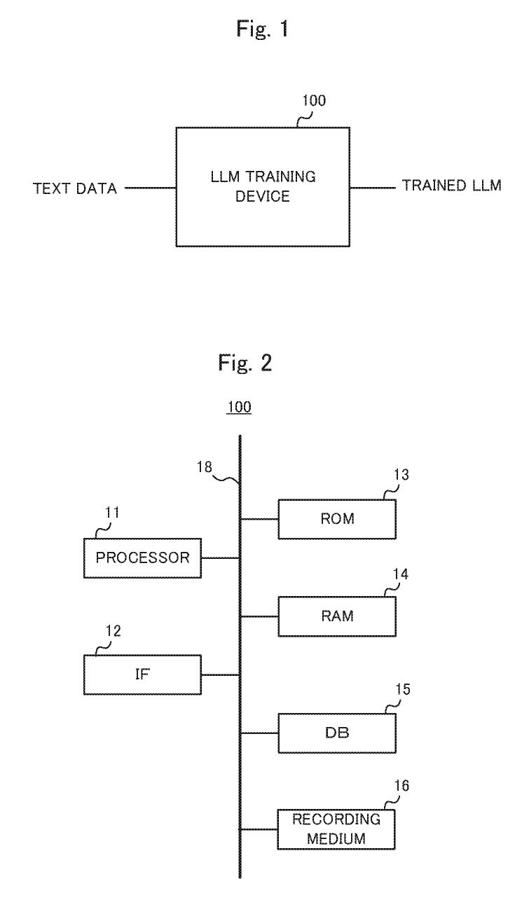

FIG. 1 illustrates an overall configuration of an LLM training device according to the present disclosure. An LLM training device 100 performs post-training on a pre-trained LLM. In this post-training, the LLM inference capability is enhanced using any text data. Specifically, the LLM training device 100 sets a pre-trained LLM as a training target. Any text data is input to the LLM training device 100. The LLM training device 100 trains the training target LLM using any text data and outputs the trained LLM.

The LLM is an example of a language model. A language model is a model that outputs an answer to an input language as an output language. The input language and the output language do not necessarily have to match. The language model may be, for example, a model that outputs an answer in a format different from a language, such as an image or a voice.

### Hardware Configuration

FIG. 2 is a block diagram illustrating a hardware configuration of the LLM training device 100. As illustrated, the LLM training device 100 includes a processor 11, an interface (IF) 12, a read only memory (ROM) 13, a random access memory (RAM) 14, a database (DB) 15, and a storage medium 16. The components are connected to each other via a bus 18, for example.

The processor 11 is a computer such as a central processing unit (CPU), and controls the entire LLM training device 100 by executing a program prepared in advance. Specifically, as the processor 11, a CPU, a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these can be used.

The processor 11 loads a program stored in the ROM 13 or the storage medium 16 into the RAM 14 and executes each piece of processing coded in the program. The processor 11 functions as a part or all of the LLM training device 100. Specifically, the processor 11 performs training processing, which will be described later.

The IF 12 transmits and receives data to and from an external device. Specifically, the LLM training device 100 receives text data through the IF 12. The LLM training device 100 outputs a trained LLM to a storage device or an external device through the IF 12.

The ROM 13 stores various programs executed by the processor 11. The RAM 14 is used as a working memory during execution of various types of processing by the processor 11.

The DB 15 stores various algorithms, data, a machine learning model, a training target LLM, other LLMs used in training of the training target LLM, and the like used when the LLM training device 100 executes training processing to be described later.

The storage medium 16 is a non-volatile non-transitory storage medium, such as a disk-shaped recording medium and a semiconductor memory. The storage medium 16 may be detachably attached to the LLM training device 100. The storage medium 16 records various programs to be executed by the processor 11.

In addition to the above, the LLM training device 100 may include a display device, such as a liquid crystal display, and an input device, such as a keyboard or a mouse. Such a display device and an input device are used, for example, by an operator of the LLM training device 100.

### Functional Configuration

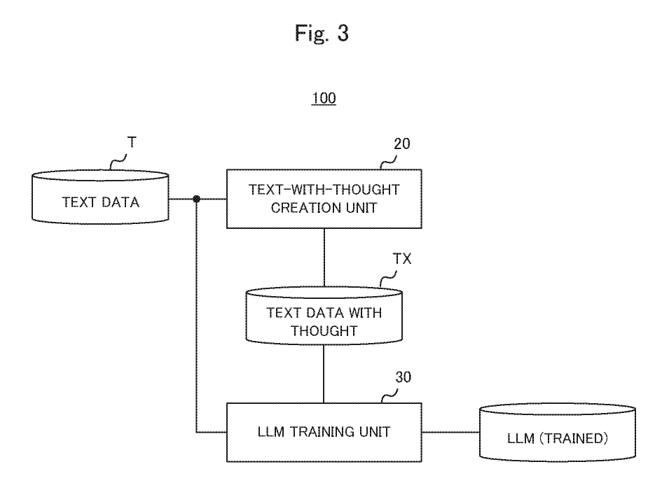

FIG. 3 is a block diagram illustrating a functional configuration of the LLM training device 100. The LLM training device 100 includes a text-with-thought creation unit 20 and an LLM training unit 30. Text data T input from the outside is input to the text-with-thought creation unit 20 and the LLM training unit 30. The text-with-thought creation unit 20 creates text data with thought TX obtained by adding thought process information to the input text data T, and outputs the text data with thought TX to the LLM training unit 30. The LLM training unit 30 trains the training target LLM by using the text data T and the text data with thought TX, and outputs the trained LLM.

### I. Text-with-thought creation unit

First, a method of creating text data with thought by the text-with-thought creation unit 20 will be described. The text-with-thought creation unit 20 generates the thought of the author of text data from any text data T. The text-with-thought creation unit 20 is an example of a data-with-thought generation means. Hereinafter, examples of a thought generation method will be sequentially described.

### Generation Method 1

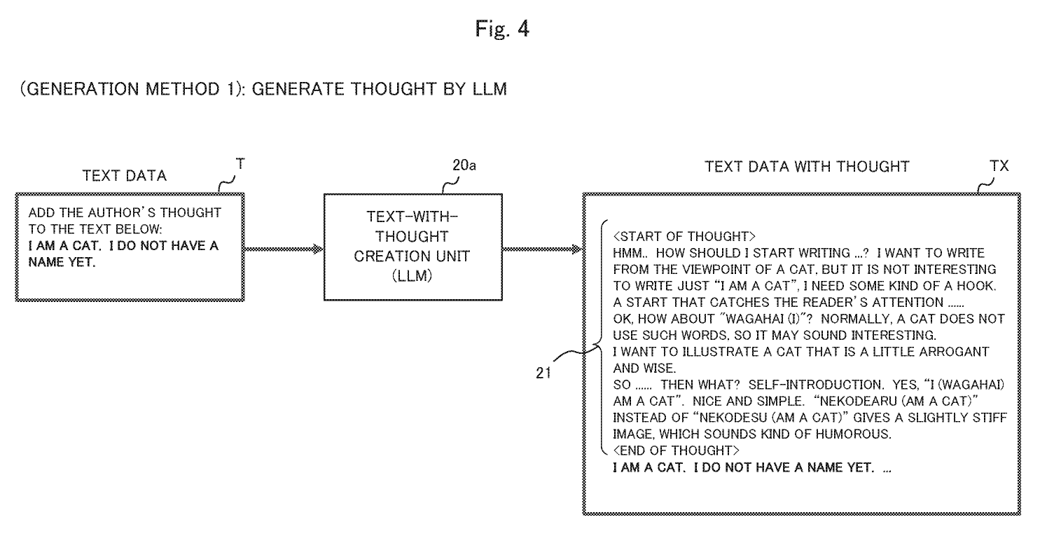

FIG. 4 schematically illustrates a thought generation method 1. A text-with-thought creation unit 20a of the thought generation method 1 includes an LLM. The text data T is input to the text-with-thought creation unit 20a. The text-with-thought creation unit 20a predicts the thought of the author who has written the text data T by the LLM. In the example of FIG. 4, the text data T to which an instruction “Add the author’s thought to the text below.” is added is input to the text-with-thought creation unit 20a. The text-with-thought creation unit 20a predicts the author’s thought based on the input text data T and generates thought process information 21 indicating the author’s thought. Then, the text-with-thought creation unit 20a outputs text data with thought TX obtained by adding the thought process information 21 to the original text data T. In this case, the LLM used for the text-with-thought creation unit 20a may be the same as or different from the training target LLM.

### Generation Method 2

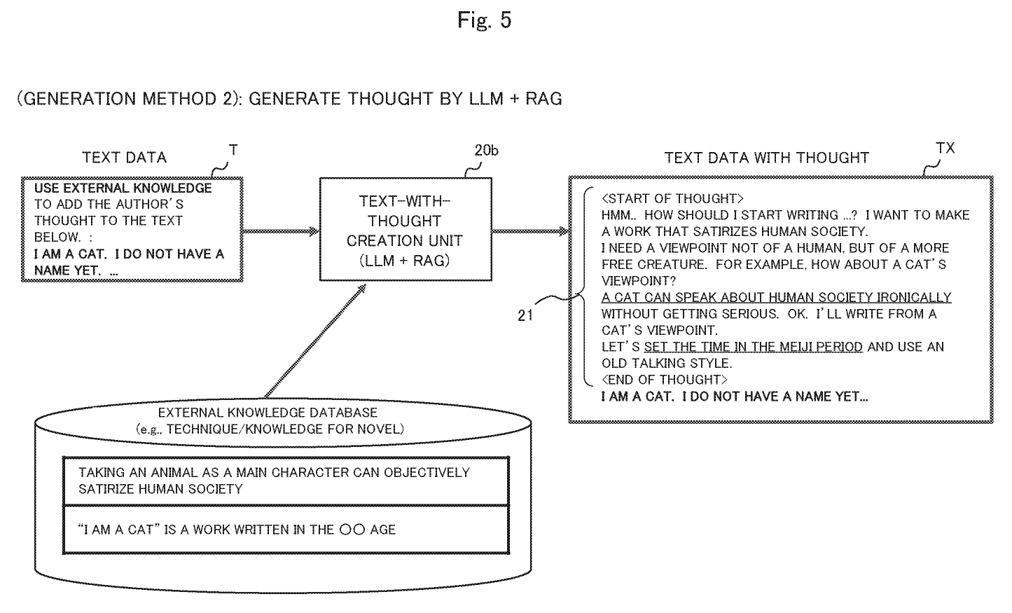

FIG. 5 schematically illustrates a thought generation method 2. A text-with-thought creation unit 20b of the generation method 2 uses an LLM and retrieval-augmented generation (RAG). RAG is a method of acquiring related information from an external knowledge source (database, document, web, and the like) and generating a text based on the acquired related information. The text data T is input to the text-with-thought creation unit 20b. The text-with-thought creation unit 20b uses RAG to predict the thought of the author who has written the text data T by the LLM. In the example of FIG. 5, the text data T to which an instruction “Add the author’s thought to the text below using external knowledge.” is added is input to the text-with-thought creation unit 20b. The text-with-thought creation unit 20b acquires the related information from the external knowledge database, predicts the author’s thought based on the input text in consideration of the related information, and generates the thought process information 21. Then, the text-with-thought creation unit 20b outputs the text data with thought TX obtained by adding the thought process information 21 to the original text data T. In this case, the LLM used for the text-with-thought creation unit 20b may be the same as or different from the training target LLM.

### Generation Method 3

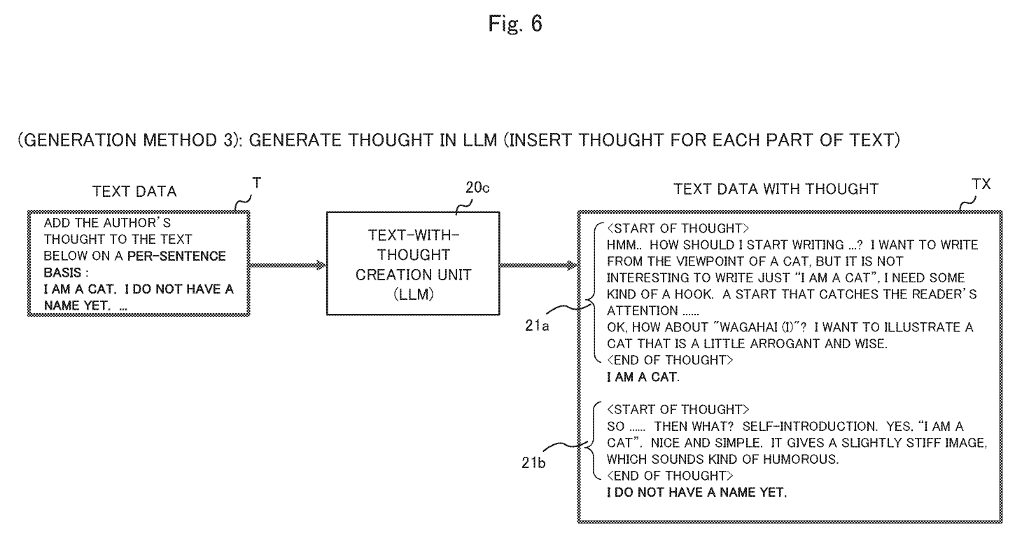

FIG. 6 schematically illustrates a thought generation method 3. The generation method 3 generates a thought using an LLM as in the generation method 1, but divides the original text data T into a plurality of parts and generates thought for each part. In the example of FIG. 6, a text-with-thought creation unit 20c generates thought process information 21a for a part “I am a cat” of the text data T and generates thought process information 21b for a part “I do not have a name yet. ...”. Then, the text-with-thought creation unit 20c generates the text data with thought TX to which the generated thought process information 21a and 21b is added.

In the above example, thought is added to each part of the text data T using the generation method 1, but instead, thought may be added to each part of the text data T using the generation method 2. That is, when the thought process information is generated using the LLM and RAG by the generation method 2, the thought process information may be generated for each part of the original text data T.

### II. LLM Training Unit

Next, a training method by the LLM training unit 30 will be described. The LLM training unit 30 performs post-training of the training target LLM using the text data with thought TX. The LLM training unit 30 is an example of a training means. Hereinafter, training methods by the LLM training unit 30 will be described.

### Training Method 1

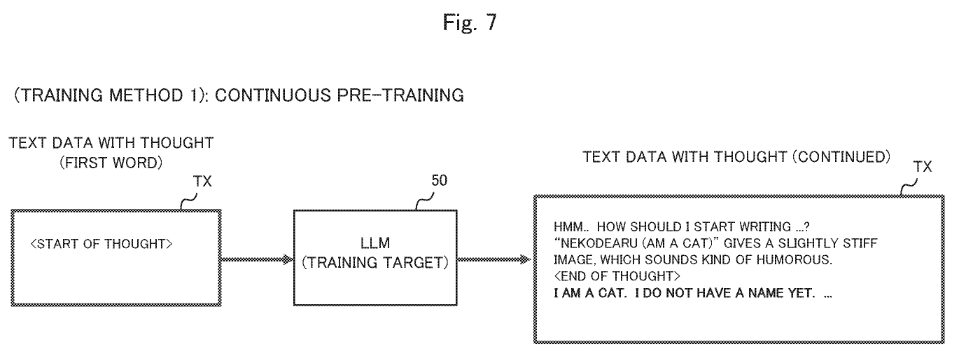

In a training method 1, the LLM training unit 30 performs continuous pre-training of the training target LLM using the text data with thought TX. Specifically, the LLM training unit 30 inputs the text data with thought TX to the training target LLM and performs training to predict the next word. FIG. 7 schematically illustrates the training method 1. The LLM training unit 30 inputs the first word of the text data with thought TX to a training target LLM 50, and causes the LLM 50 to predict the next word. Then, the LLM training unit 30 trains the LLM 50 in such a way that the next word predicted by the LLM 50 exactly matches the next word of the text data with thought TX. As a result, the training target LLM 50 can be trained using a part of thought process information of the text data T.

### Training Method 2

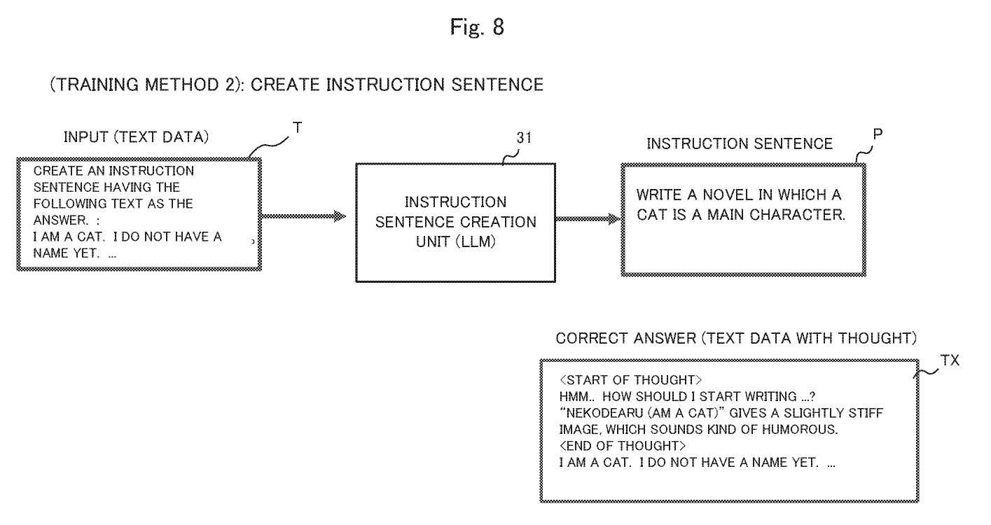

In a training method 2, the LLM training unit 30 trains the LLM 50 using the text data with thought TX as the correct answer. FIG. 8 schematically illustrates the training method 2. In the training method 2, the LLM training unit 30 includes an instruction sentence creation unit 31. The instruction sentence creation unit 31 creates an instruction sentence P in which the text data T is an answer. For example, as illustrated in FIG. 8, the LLM training unit 30 inputs the text data T to which an instruction “Create an instruction sentence having the following text as the answer.” is added to the instruction sentence creation unit 31. The instruction sentence creation unit 31 creates the instruction sentence P using an LLM. In the above example, the instruction sentence creation unit 31 creates the instruction sentence P “Write a novel in which a cat is the main character.”. The LLM used by the instruction sentence creation unit 31 may be the same as or different from the training target LLM 50. The instruction sentence creation unit 31 is an example of an instruction sentence creation means.

Then, the LLM training unit 30 trains the training target LLM 50 using the obtained instruction sentence P and the text data with thought TX. There are a plurality of training methods using an instruction sentence, and the training methods will be sequentially described below.

### Training Method 2-1

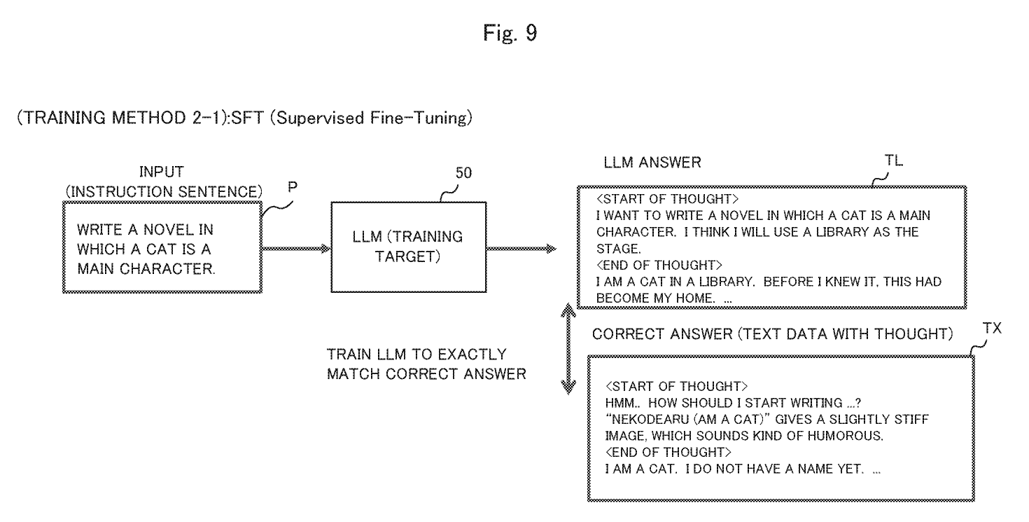

In a training method 2-1, supervised fine-tuning (SFT) is performed using an instruction sentence. SFT is a method of inputting a problem to an LLM to predict an answer, and training the LLM in such a way that the predicted answer exactly matches the correct answer. FIG. 9 schematically illustrates the training method 2-1. The LLM training unit 30 inputs the instruction sentence P to the training target LLM 50 and obtains an LLM answer TL. Then, the LLM training unit 30 uses the text data with thought TX as a correct answer, and trains the LLM 50 in such a way that the LLM answer TL exactly matches the text data with thought TX.

### Training Method 2-2

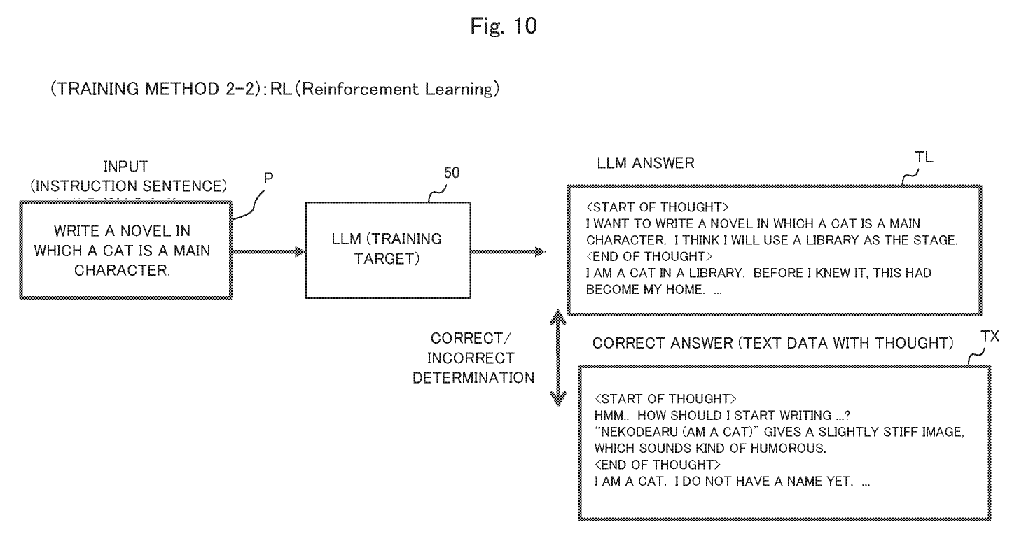

In a training method 2-2, reinforcement learning (hereinafter also referred to as “RL”) is performed using an instruction sentence. RL is a method of inputting a problem to an LLM to predict an answer, and training the LLM according to correct/incorrect determination (reward) of the predicted answer. FIG. 10 schematically illustrates the training method 2-2. The LLM training unit 30 inputs the instruction sentence P to the training target LLM 50 and obtains an LLM answer TL. Then, the LLM training unit 30 determines whether the LLM answer TL is correct or incorrect using the text data with thought TX as the correct answer, and trains the LLM 50 based on the determination result. Proximal Policy Optimization (PPO) or Direct Preference Optimization (DPO) can be used as the algorithm of RL. PPO is described in Reference Literature 1 below and DPO is described in Reference Literature 2 below. These documents are incorporated herein by reference.

### Reference Literature 1

Proximal Policy Optimization Algorithms, John Schulman, Filip Wolski, Prafulla Dhariwal, Alec Radford, Oleg Klimov, https://arxiv.org/abs/1707.06347

### Reference Literature 2

Direct Preference Optimization: Your Language Model is Secretly a Reward Model

Rafael Rafailov, Archit Sharma, Eric Mitchell, Stefano Ermon, Christopher D. Manning, Chelsea Finn, https://arxiv.org/abs/2305.18290

As the training method 2-2, the following two methods are conceivable by a correct/incorrect determination method.

### Training Method 2-2-1

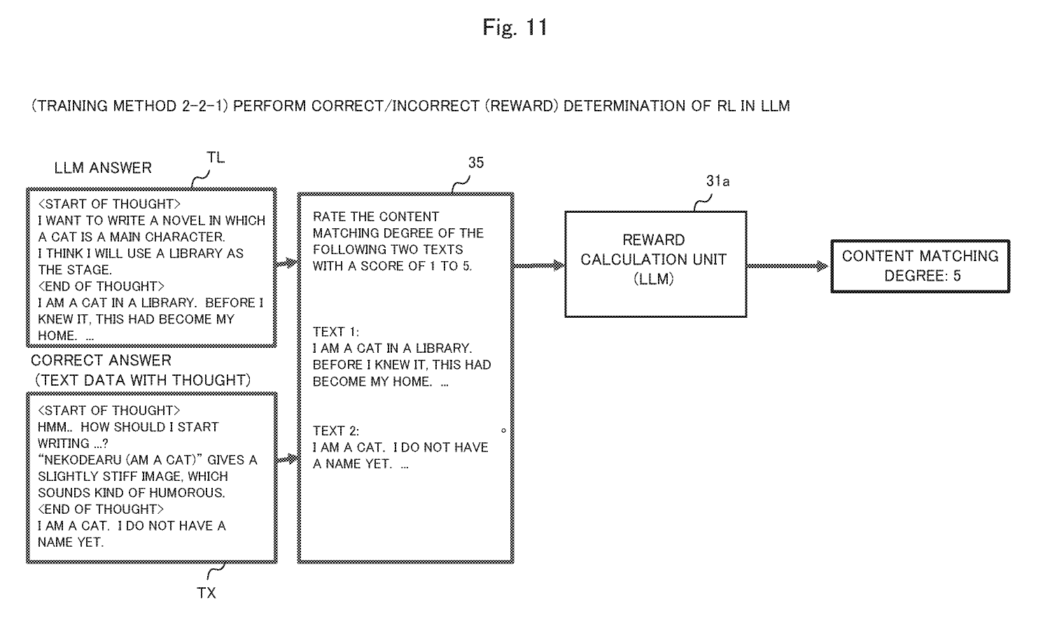

In a training method 2-2-1, correct/incorrect determination (reward calculation) is performed in an LLM. FIG. 11 schematically illustrates the training method 2-2-1. The LLM training unit 30 calculates a reward between the LLM answer TL and the text data with thought TX as a correct answer by a reward calculation unit 31a. The reward calculation unit 31a includes an LLM. Specifically, the LLM training unit 30 inputs a prompt 35 for calculating the content matching degree between the LLM answer TL and the text data with thought TX to the LLM, and outputs the calculated matching degree as a reward. In the example of FIG. 11, the prompt 35 includes text of the LLM answer TL as a text 1, includes text of the text data with thought TX as a text 2, and outputs a score indicating the matching degree between the two as a reward. Then, the LLM training unit 30 performs reinforcement learning of the training target LLM 50 using the obtained reward. The LLM used as the reward calculation unit 31a may be the same as or different from the training target LLM.

### Training Method 2-2-2

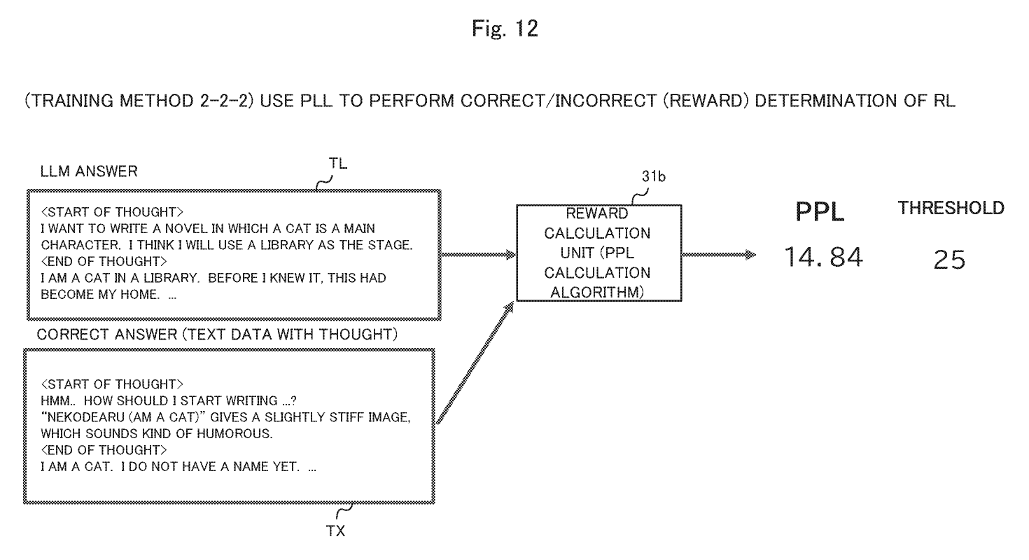

In a training method 2-2-2, correct/incorrect determination (calculation of reward) is performed using perplexity (PPL). FIG. 12 schematically illustrates the training method 2-2-2. The LLM training unit 30 calculates a reward between the LLM answer TL and the text data with thought TX as a correct answer by a reward calculation unit 31b. The reward calculation unit 31b calculates PPL using a PPL calculation algorithm.

PPL is an index indicating “how easily a model predicts" a certain text. A smaller numerical value of PPL indicates that the model can naturally predict the text. For example, “Today’s weather is ...” followed by “good” is natural and easy to predict. On the other hand, “Today’s weather is ...” followed by “the library” is a little unnatural and difficult to predict. Thus, PPL is a numerical value indicating “How easy is the next word to predict?”.

Specifically, in the example of FIG. 12, the LLM answer TL includes a first text “<Thinking Start> I want to write a novel with a cat as a main character ... <Thinking End>” and a following text “I am a library ...”. Here, the reward calculation unit 31b calculates, as a probability, whether or not the word “I” that is the word of the correct answer is likely to appear as a word next to the first text “<Thinking Start> I want to write a novel with a cat as a main character ... <Thinking End>”. If this probability is high, PPL is low. The reward calculation unit 31b repeats this processing for all the words and uses PPL as a reward. If PPL is smaller than a predetermined threshold, the reward calculation unit 31b sets a negative PPL (inverted to increase the reward for a smaller value) as a reward. Then, the LLM training unit 30 performs reinforcement learning of the training target LLM 50 using the obtained reward.

### Training Method 2-3

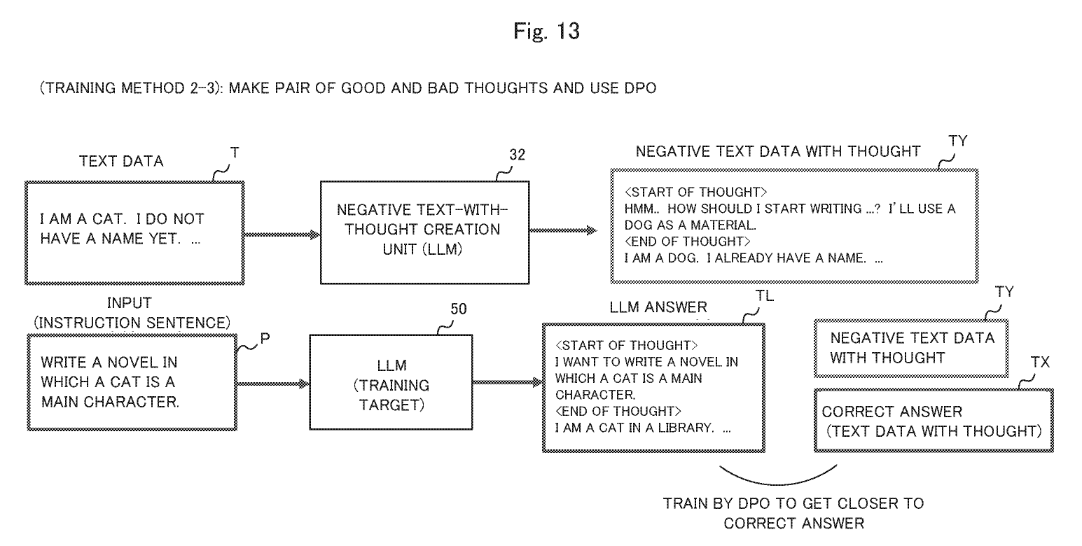

A training method 2-3 is a method of performing RL by DPO using an instruction sentence. DPO is one of the reinforcement learning algorithms that train an LLM from good and bad examples. FIG. 13 schematically illustrates the training method 2-3. The LLM training unit 30 includes a negative text-with-thought creation unit 32. The negative text-with-thought creation unit 32 includes an LLM. The LLM used as the negative text-with-thought creation unit 32 may be the same as or different from the training target LLM.

The negative text-with-thought creation unit 32 basically creates text data using the same generation method as the above-described text-with-thought creation unit 20. However, when the text data with thought created by the text-with-thought creation unit 20 is treated as a positive example, the negative text-with-thought creation unit 32 creates text data having contents corresponding to its negative example. A “negative example” refers to “undesirable” or “incorrect” data in the field of machine learning and the like, serving as a counterpart to a “positive example” indicating a correct answer. In the example of FIG. 13, the negative text-with-thought creation unit 32 uses “dog” instead of “cat” in the text data T and creates a sentence “I already have a name.” instead of the sentence “I do not have a name yet.”.

As the training processing, the LLM training unit 30 first inputs the original text data T to the negative text-with-thought creation unit 32, and creates negative text data with thought TY. Next, the LLM training unit 30 inputs the instruction sentence P created by the instruction sentence creation unit 31 described above to the training target LLM 50 and acquires the LLM answer TL. Then, the LLM training unit 30 trains the training target LLM 50 in such a way that the LLM answer TL approaches the text data with thought TX of the correct answer by DPO, by using the text data with thought TX created from the original text data T and the negative text data with thought TY created by the negative text-with-thought creation unit 32.

### Training Method 2-4

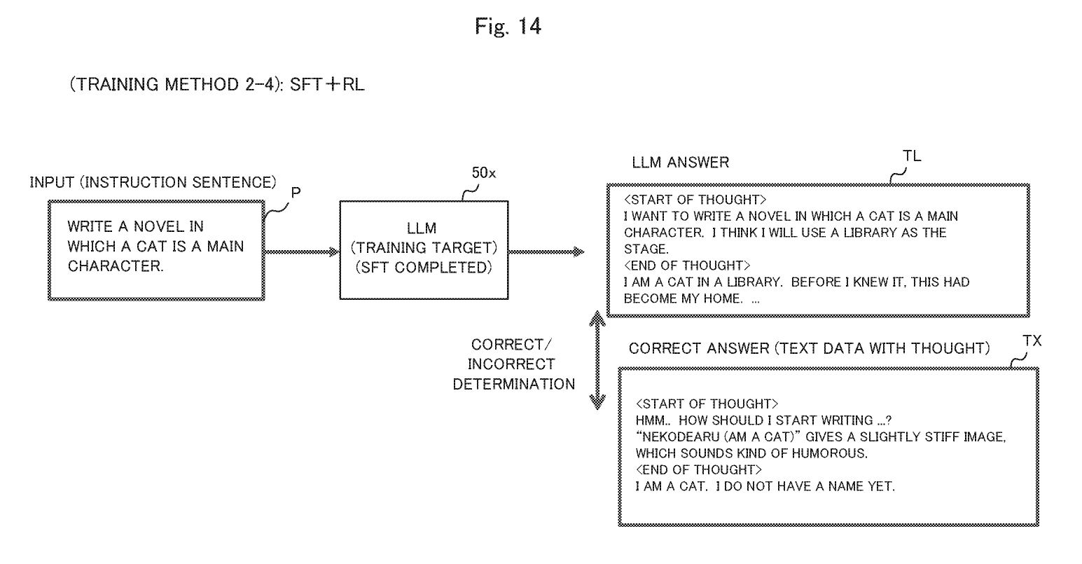

A training method 2-4 is a method of combining SFT and RL described above. FIG. 14 schematically illustrates the training method 2-4. The LLM training unit 30 trains the training target LLM 50 by SFT according to the training method 2-1 and generates a trained LLM 50x. Next, the LLM training unit 30 performs training by RL on the LLM 50x trained by SFT. Specifically, the LLM training unit 30 inputs the instruction sentence P to the trained LLM 50x to acquire the LLM answer TL, and performs training by RL using the LLM answer TL and the text data with thought TX which is a correct answer, for example, using the training method 2-2.

### Training Processing

Next, training processing will be described.

### Case of Training Method 1

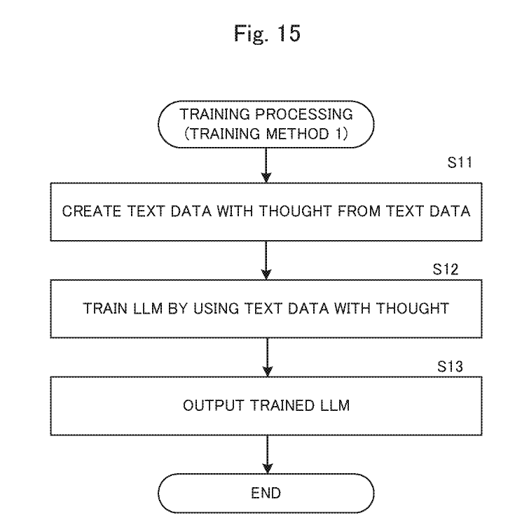

FIG. 15 is a flowchart of training processing in the case of the training method 1. In the training method 1, the LLM training unit 30 performs continuous pre-training of the training target LLM using the text data with thought. This processing is achieved by the processor 11 illustrated in FIG. 2 executing a program prepared in advance and operating as each component illustrated in FIG. 3.

First, the text-with-thought creation unit 20 creates the text data with thought from text data (step S11). This processing is performed using any of the generation methods 1 to 3 described above. Next, the LLM training unit 30 trains the training target LLM using the text data with thought (step S12). Specifically, the LLM training unit 30 performs continuous pre-training of the training target LLM using the text data with thought. Then, the LLM training unit 30 outputs the trained LLM (step S13), and the training processing ends.

### Case of Training Method 2

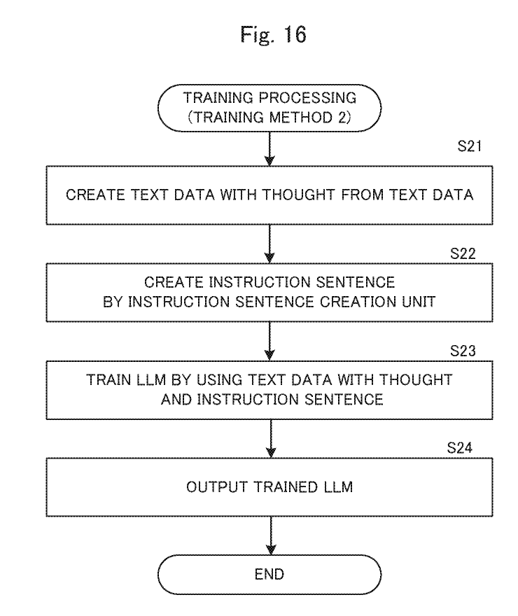

FIG. 16 is a flowchart of training processing in the case of the training method 2. In the training method 2, the LLM training unit 30 trains the training target LLM by using an instruction sentence and using the text data with thought as a correct answer. This processing is achieved by the processor 11 illustrated in FIG. 2 executing a program prepared in advance and operating as each component illustrated in FIG. 3.

First, the text-with-thought creation unit 20 creates the text data with thought from text data (step S21). This processing is performed using any of the generation methods 1 to 3 described above. Next, the instruction sentence creation unit 31 creates an instruction sentence from the text data (step S22). Next, the LLM training unit 30 trains the training target LLM using the instruction sentence and the text data with thought (step S23). Specifically, the LLM training unit 30 inputs the instruction sentence to the training target LLM 50 to generate an LLM answer, and trains the training target LLM using the LLM answer and the text data with thought. This processing is performed using any of the training methods 2-1 to 2-4 described above. Then, the LLM training unit 30 outputs the trained LLM (step S24), and the training processing ends.

### Effect

As described above, according to the method of the present disclosure, the LLM inference capability can be enhanced using any text data. While existing methods are limited to enhancing the LLM with respect to specific tasks such as mathematics and programming, the method of the present disclosure can enhance the ability of LLM with respect to various tasks. In particular, the method of the present disclosure exhibits an effect in a task in which it is impossible to make a clear correct/incorrect determination, such as storage and understanding of scientific knowledge, paper generation, and novel generation. In the method of the present disclosure, if there is a “mathematical text” or a “programming code”, it is possible to enhance mathematical ability and programming ability even if there is no correct/incorrect determination. For example, only a specialized book of mathematics or a program created by a leading engineer is necessary.

### Second Example Embodiment

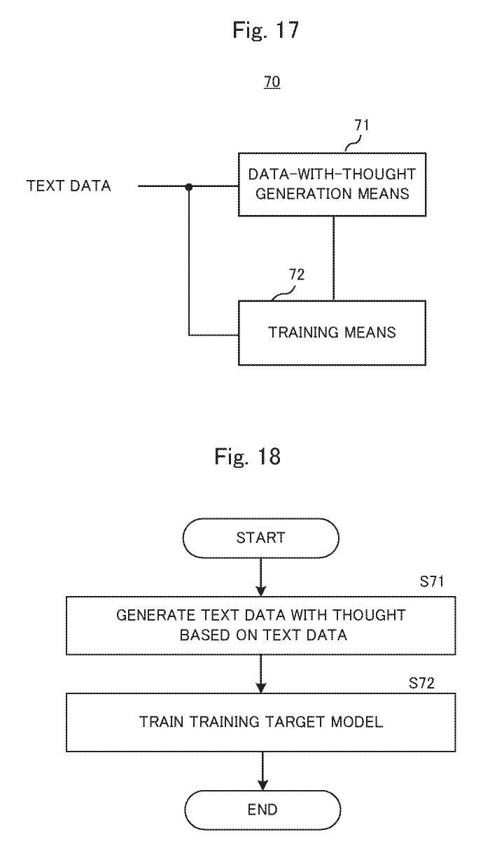

FIG. 17 is a block diagram illustrating a functional configuration of a training device 70 according to a second example embodiment. The training device 70 includes a data-with-thought generation means 71 and a training means 72.

FIG. 18 is a flowchart of processing by the training device according to the second example embodiment. The data-with-thought generation means 71 generate text data with thought to which thought process information is added based on input text data (step S71). The training means 72 trains a training target language model by using the text data with thought (step S72).

The training device 70 of the second example embodiment can provide a training method capable of enhancing the ability of LLM using any text data.

A part or all of the example embodiments described above may also be described as the following supplementary notes, but not limited thereto.

### Supplementary note 1

A training device comprising

a data-with-thought generation means configured to generate text data with thought to which thought process information is added based on input text data, and

a training means configured to train a training target language model by using the text data with thought.

### Supplementary note 2

The training device according to Supplementary note 1, further comprising an instruction sentence generation means configured to generate an instruction sentence for outputting the text data as an answer based on the text data,

wherein the training means updates a parameter of the training target language model by using the text data, the text data with thought, and the instruction sentence.

### Supplementary note 3

The training device according to Supplementary note 1, wherein the data-with-thought generation means inputs the text data to a first language model, and causes the first language model to predict a thought of a creator of the text data to generate the text data with thought.

### Supplementary note 4

The training device according to Supplementary note 1, wherein the data-with-thought generation means inputs the text data to a first language model, and causes the first language model to predict a thought of a creator of the text data by using external knowledge to generate the text data with thought.

### Supplementary note 5

The training device according to Supplementary note 1, wherein the data-with-thought generation means generates the text data with thought for each of a plurality of parts included in the text data.

### Supplementary note 6

The training device according to Supplementary note 2, wherein the instruction sentence generation means inputs the text data to a second language model and causes the second language model to generate the instruction sentence.

### Supplementary note 7

The training device according to Supplementary note 2, wherein the training means inputs the instruction sentence to the training target language model, and performs supervised learning of the training target language model in such a way that an output of the training target language model matches the text data with thought.

### Supplementary note 8

The training device according to Supplementary note 2, wherein the training means inputs the instruction sentence to the training target language model, and performs reinforcement learning of the training target language model by using an output of the training target language model and the text data with thought.

### Supplementary note 9

A training method executed by a computer, comprising

generating text data with thought to which thought process information is added based on input text data, and

training a training target language model by using the text data with thought.

### Supplementary note 10

A program for causing a computer to execute processing of

generating text data with thought to which thought process information is added based on input text data, and

training a training target language model by using the text data with thought.

Some or all of the configurations described in Supplementary Notes 2 to 8 dependent on the above-described Supplementary Note 1 can also be dependent on Supplementary Notes 9 and 10 by a dependency relationship similar to that of Supplementary Notes 2 to 8. Some or all of the configurations described as the Supplementary Notes can be similarly dependent on not only the Supplementary Notes 1, 9, and 10, but also diverse pieces of hardware and software, various recording means for recording software, or systems without departing from the above-described example embodiments.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

### DESCRIPTION OF SYMBOLS

11 Processor

20, 20a, 20b, 20c Text-with-thought creation unit

30 LLM training unit

31 Instruction sentence creation unit

31a, 31b Reward calculation unit

32 Negative text-with-thought creation unit

50, 50x Training target LLM

1. A training device comprising
a memory configured to store instructions; and
one or more processors configured to execute the instructions to:
generate text data with thought to which thought process information is added based on input text data, and
train a training target language model by using the text data with thought.

2. The training device according to claim 1, wherein the one or more processors are further configured to execute the instructions to generate an instruction sentence for outputting the text data as an answer based on the text data,
wherein the one or more processors update a parameter of the training target language model by using the text data, the text data with thought, and the instruction sentence.

3. The training device according to claim 1, wherein one or more processors input the text data to a first language model, and cause the first language model to predict a thought of a creator of the text data to generate the text data with thought.

4. The training device according to claim 1, wherein the one or more processors inputs the text data to a first language model, and cause the first language model to predict a thought of a creator of the text data by using external knowledge to generate the text data with thought.

5. The training device according to claim 1, wherein the one or more processors generate the text data with thought for each of a plurality of parts included in the text data.

6. The training device according to claim 2, wherein the one or more processors input the text data to a second language model and cause the second language model to generate the instruction sentence.

7. The training device according to claim 2, wherein the one or more processors input the instruction sentence to the training target language model, and perform supervised learning of the training target language model in such a way that an output of the training target language model matches the text data with thought.

8. The training device according to claim 2, wherein the one or more processors input the instruction sentence to the training target language model, and perform reinforcement learning of the training target language model by using an output of the training target language model and the text data with thought.

9. A training method executed by a computer, comprising
generating text data with thought to which thought process information is added based on input text data, and
training a training target language model by using the text data with thought.

10. A non-transitory computer-readable recording medium storing a program, the program causing a computer to execute processing comprising:
generating text data with thought to which thought process information is added based on input text data, and
training a training target language model by using the text data with thought.
